(19) United States
(12) Patent Application Publication
(10) Pub. No.: US 2017/0182760 A1
(43) Pub. Date: Jun. 29, 2017

(54) THERMOPLASTIC COMPOSITE AND ITS MANUFACTURING

(71) Applicant: Epurex Films GmbH & Co. KG, Bomlitz (DE)

(72) Inventor: Wolfgang Stenbeck, Bomlitz (DE)

(21) Appl. No.: 15/309,460

(22) PCT Filed: May 11, 2015
(86) PCT No.: PCT/EP2015/060342

§ 371 Date: Nov. 8, 2016

(30) Foreign Application Priority Data
May 14, 2014 (EP) 14168215.3

(51) Int. Cl. B32B 37/15; B32B 7/12; B32B 27/36; B32B 27/40; B32B 27/30; B32B 5/02; B32B 27/12

(52) U.S. Cl. CPC B32B 37/153; B32B 5/02; B32B 7/12; B32B 27/12; B32B 27/40; B32B 27/30; B32B 27/36

(57) ABSTRACT

The present invention provides a roll-to-roll continuous manufacturing process for producing a thermoplastic composite laminate comprising extruding a thermoplastic resin into a film article, surface treating a fiber material with a special sizing and laminating at least one layer of thermoplastic film and at least one layer of the surfaced treated fiber material into a composite sheet at a temperature above the melting or softening point of the thermoplastic film and under pressure applied by nipping rolls or nipping belts.

The present invention is directed in general to thermoplastic polymers and in particular to methods of producing thermoplastic composites.

Edwards, in U.S. Published Patent Application No. 2002/0099427 describes a reinforced thermoplastic article comprising a) a first thermoplastic layer; and b) a fiber-reinforced thermoplastic composite that contains a thermoplastic resin and a plurality of continuous reinforcing fibers impregnated with the resin, wherein the first thermoplastic layer is thermoformed or blow-molded to the thermoplastic composite.

U.S. Published Patent Application No. 2008/0160281 in the name of Vickery et al., provides a composition for a reinforcing fiber used to reinforce thermoset resins comprising: at least one silane coupling agent; and one or more film forming agents, wherein said composition is free of any additives that are typically included in conventional sizing applications to impose desired properties or characteristics to the size composition.

Larson et al., in U.S. Published Patent Application No. 2008/0233364 detail a dimensionally stable continuous laminate structure comprising: a reinforcement layer comprising, by weight, from about 20% to about 80% fiber reinforcement and from about 80% to about 20% thermoset polymer selected from polyester, phenolic, epoxy and mixtures thereof; a surface layer comprising a substrate layer and a decorative layer, the substrate layer comprising, by weight, from about 20% to 80% by weight fiber reinforcement and from about 80% to about 20% polymer selected from polyvinyl chloride, polyester, phenolic, epoxy and mixtures thereof, and the decorative layer comprising at least one of polyvinyl chloride, acrylic, and polyurethane; an adhesive layer disposed between the reinforcement layer and the substrate layer of the surface layer; an adhesive primer layer disposed between the reinforcement layer and the adhesive layer, wherein the adhesive primer is of a material composition different than the adhesive layer.

U.S. Published Patent Application No. 2012/0061013 in the name of Kubota et al., discloses a composite article and a process for manufacturing the composite article. The composite article comprises multiple layers including high tenacity fibers incorporated into a fabric and a core thermoplastic resin. The fabric may be coated with a surface treatment agent and a polymer matrix. resin. Single or multiple layers of the composite articles may be formed into a composite part said to have high strength, rigidity, fast molding cycle time and extremely good conformability in a 3-dimensional mold. The composite parts formed by the process of Kubota et al. are said to have high part strength in all directions.

Schleiermacher et al., in U.S. Published Patent Application No. 2012/0148803 teach a long fiber reinforced polyurethane molded part which has three-dimensional raised structures, especially ribs, struts andor domes, characterized by further containing short fibers in addition to said long fibers, wherein the weight ratio of short fibers and/or plate-like fillers to the fiber-free polyurethane matrix in a volume of ribs, struts and/or domes is higher than the weight ratio of short fibers and/or plate-like fillers to the fiber-free polyurethane matrix in two-dimensional areas outside the raised structures.

U.S. Published Patent Application No. 2012/0156376 in the name of Kim et al. describes method for manufacturing a composite molded body, and more particularly, a method for manufacturing a composite molded body, comprising: a step of manufacturing a molded body containing polyethylene terephthalate, acrylonitrile-butadiene-styrene, and glass or carbon fibers; and a step of coating the molded body with a reactive polyurethane composition or with a rubber composition. The composite molded body can be used in lieu of a wheel hub casting to minimize the weight of a wheel, can be manufactured at a low cost in terms of materials, and can be mass-produced. The composite molded body is said to have remarkably superior adhesion to the coating composition, and the strength and durability thereof corresponds to that of cast metal such as cast iron, stainless steel, aluminum, etc.

Cheng, in U.S. Published Patent Application No. 2012/0177927 provides a method for making a molded carbon fiber prepreg which includes the steps of: (a) thermocompressing a pristine carbon fiber prepreg that includes a carbon fiber substrate and a matrix resin impregnated into the carbon fiber substrate, and a thermoplastic material at an elevated temperature such that the thermoplastic material and the matrix resin of the pristine carbon fiber prepreg are subjected to a crosslinking reaction so as to form a crosslinked thermoplastic layer on the pristine carbon fiber prepreg; and (b) injection molding a thermoplastic elastomer onto the crosslinked thermoplastic layer.

U.S. Published Patent Application No. 2013/0252059 in the name of Choi et al., discloses a battery pack case assembly for an electric or hybrid vehicle and a method for manufacturing the same. The battery pack case assembly includes a case body and a cover. The case body receives a battery pack, and the cover is coupled to the case body. The case body is formed of a plastic composite in which a long fiber or a blend of a long fiber and a continuous fiber is used as a reinforcing fiber in a plastic matrix. A separate reinforced member is bonded to both side bracket parts for coupling to a vehicle body, and is formed of a plastic composite in which a long fiber, a continuous, or a blend of a long fiber and a continuous fiber is used as the reinforcing fiber in the plastic matrix.

U.S. Published Patent Application No. 2013/143025 in the name of Kibayashi et al. discloses a thermoplastic resin impregnated tape having a carbon fiber with a sizing. The thermoplastic resin is a heat resistant thermoplastic resin, a polyamideimide resin, a polyetherimide resin, a polysulfone resin, a polyether sulfone resin a polyetheretherketone resin, a polyetherketoneketone resin and a poylphenylenesulfide resin. There is no disclosure of extruding a thermoplastic resin into a film article.

German published patent application DE 3822297 discloses a process for the manufacture of a thermoplastic composite laminate comprising the steps of extrusion of a thermoplastic resin to a film, at least one surface of this film is added with a fleece comprising filaments of a thermoplastic resin and whereas this unit can be rolled under pressure and results in inherent reinforcement. But DE 3822297 does not disclose a special thermoplastic material and the step of treating a fiber material with a polymeric sizing agent. Furthermore DE 3822297 discloses only thermoplastic fibers but no carbon-, glass- or other fibers.

European published patent application EP 1623822 discloses a hydrogenated copolymer-containing laminate comprising a substrate layer, an adhesive layer and a hydrogenated copolymer compostion layer which is laminated on and bonded to the substrate layer through the adhesive layer

U.S. Published Patent Application No. 2005/008813 in the name of Demon et al. discloses a layered textile composite product comprising a nonwoven needled layer, which is bonded with an adhesive layer to a polymeric or polyolefin film layer. An adhesive layer is used to adhere a nonwoven needled layer to a polymeric film layer, U.S. Published Patent Application No. 2005/106965 in the name of Wevers et al. discloses a multilayer structure comprising (A) a fabric and (B) a polymeric layer comprising a substantially random interpolymer comprising in polymerized. form i) one or more α-olefin monomers and ii) one or more vinyl or vinylidene monomers and optionally iii) other polymerizable ethylenically unsaturated monomers, whereas layer (B) being free from a substantially amount of tackifier. This invention describes the coating of polymeric materials to textile-fabric for soft-elastic applications.

There continues to be a need in the art for new manufacturing process for producing thermoplastic composite laminates, which allows cost effective and fast continuous manufacturing and produces material which is suitable for reinforcing structural units e.g. automotive parts.

Accordingly, the present invention provides such a roll-to-roll continuous manufacturing process for producing thermoplastic composite laminates. A thermoplastic polyurethane resin optionally having soft segments in its backbone structure is extruded into a film article by either blown film or flat-die process. A silane coupling agent is optionally added in the thermoplastic film. A fiber material which may be a woven cloth, fiber fleece, or unidirectional fibers is surfaced treated with a polymer based sizing, and optional silane coupling agent is added.

The sizing is applied on the fibers to achieve a better adhesion of the fibers to the matrix material. The sizing serves as adhesion promotor between fiber and matrix. To this end, however, the sizing must be matched to the corresponding matrix system. Fibers with an epoxy sizing (silane) are of limited use in thermoplastics. With thermoplastic polyurethane matrix materials, it is advisable to use fibers with coatings of polyurethane resins (for example Toho Tenax 24k HTS-fiber F13).

Other film-forming materials for sizings may be starch derivatives, polymers and copolymers of vinyl acetate and acrylic esters, epoxy resin emulsions, polyesters, polypropylene, polybutylene terephthalate and polyamides in which may contain silanes as adhesion promoters.

At least one layer of thermoplastic film and at least one layer of the surfaced treated fiber material are laminated into composite sheets under temperatures above the melting or softening point of the thermoplastic film and under pressure that is applied by nipping rolls or nipping belts. A continuous roll-to-roll lamination process realized in the above described way can produce thermoplastic composite sheets using rolls of fiber material and thermoplastic film materials.

The resulting thermoplastic/fiber composite sheets can be used to make parts by thermoforming in short molding cycles and are recyclable. These parts possess good chemical resistance, mechanical properties and are paintable or printable without priming or other surface preparations.

These and other advantages and benefits of the present invention will be apparent from the Detailed Description of the Invention herein below.

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

Thermoplastic films suitable for use in the present invention as a substrate for the thermoplastic composite sheet include, without limitation, polyethylene terephthalate glycol-modified (PETG), TRITAN™ copolyester, polycarbonate (PC), polyurethanes (TPU), poly(methyl methacrylate) (PMMA), polyacrylonitrile-co-butadiene-co-styrene (ABS), polycarbonate/acrylonitrile butadiene styrene (PC/ABS) blend and polystyrene (PS). Both flame retardant and non-flame retardant grades of the thermoplastic films are suitable for use in the present invention. In an embodiment of the inventions polycarbonate (PC) or polycarbonate copolymers are used as thermoplastic composite sheet material. In another embodiment of the inventions polyurethane (TPU) is used as thermoplastic composite sheet material.

The thermoplastic films preferably will have a high enough melt flowability, above 200° C., for the inventive composite lamination process. Preferably, the melt flow index of the extruded film tested at 210° C./300° C. and under 3.8 kg/8.7 kg according to ASTM D-1238 is above 2 g/10 min., more preferably between 5 g/10 min. and 60 g/10 min. and most preferably from 20 g/10 min. and 40 g/10 min.

The films also are preferably amorphous or with very low crystallinity, and preferably have a glass transition temperature lower than 170° C., more preferably from 70 to 160° C. determined by differential scanning calorimetry (DSC) according to DIN EN ISO 11357-2 at a heating rate of 10 K/min/20 K/min with the definition of Tg midpoint temperature (tangent method) according to DIN 51005 and nitrogen determined as protective gas. When the continuous fiber reinforced sheet composite made of the above plastic films is thermoformed, the amorphous feature of the polymer substrate can significantly reduce the forming cycle time and warping of final parts. Suitable polycarbonate resins for preparing thermoplastic films useful in the present invention are homopolycarbonates and copolycarbonates, both linear or branched resins and mixtures thereof.

The polycarbonates have a weight average molecular weight of preferably 10,000 to 200,000, more preferably 20,000 to 80,000 (Mw, measured by gel permeation chromatography in methylene chloride at 25° C. and the polycarbonate/polystyrene as standard) and their melt flow rate, per ASTM D-1238 at 210° C./300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, New York, 1964).

In the present context, dihydroxy compounds suitable for the preparation of the polycarbonates of the invention conform to the structural formulae (1) or (2) below.

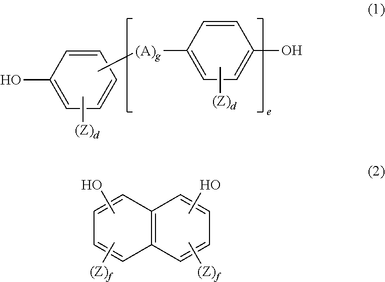

wherein

A denotes an alkylene group with 1to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

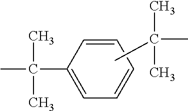

e and g both denote the number 0 to 1;

Z denotes F, Cl, Br or C₁-C₄-alkyl and if several Z radicals are substituents in one aryl radical, they may be identical or different from one another;

d denotes an integer of from 0 to 4; and

f denotes an integer of from 0 to 3.

Among the dihydroxy compounds useful in the practice of the invention are hydroquinone, resorcinol, bis-(hydroxyphenyl)-alkanes, bis-(hydroxy-phenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4- hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′- dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention are phenolphthalein-based polycarbonate, copolycarbonates and terpoiy-carbonates such as are described in U.S. Pat. Nos. 3,036,036 and 4,210,741, both of which are incorporated by reference herein.

The polycarbonates of the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No. 3,544,514, which is incorporated herein by reference. The following are some examples of polyrhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; ,1,1,1-tri-(4- hydroxyphenyl)-ethane; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688 incorporated herein by reference, may be used. Suitable polycarbonate resins are available in commerce, for instance, from Bayer MaterialScience AG, Leverkusen, Germany under the MAKROLON® trademark. The polycarbonate is present in the thermoplastic blend in from preferably 50 to 70% by weight of the combined weights of the thermoplastic aromatic polycarbonate and thermoplastic polyurethane present.

Aliphatic thermoplastic polyurethanes are particularly preferred in the methods of the present invention such as those prepared according to U.S. Pat. No. 6,518,389, the entire contents of which are incorporated herein by reference.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 85 Shore D (determined by DIN EN ISO 868 and DIN ISO 7619-1).

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially un-effected.

Suitable polyester polyols include the ones which are prepared by polymerizing ε-caprolactone using an initiator such as ethylene glycol, ethanolamine and the like. Further suitable examples are those prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri- methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the present invention may be, for example, organic aliphatic diisocyanates including, for example, 1,4-tetramethylene diisocyanate, 1,6-hexamethylene diisocyanate, 2,2,4-trimethyl-1,6- hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl-cyclohexane, bis-(4-isocyanato-3-methylcyclohexyl)-methane, α,α,α′,α′-tetramethyl-1,3- and/or -1,4-xylylene diisocyanate, 1-isocyanate-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic dials containing 2 to 14 carbon atoms, such as ethanediol, 6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethylethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl- substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight dials/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N-N′-dimtethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. %, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for instance, from Bayer MaterialScience AG, Germany, under the TEXIN® trademark, from BASF SE, Germany, under the ELASTOLLAN® trademark and from Lubrizol Corporation under the trade names of ESTANE® ISOPLAST® and PELLETHANE®.

Many different fibers or strands and combinations may be utilized in the practice of the present invention, including but not limited to glass from companies such as 3B the fiber glass company, Hoeilaart, Belgium, PPG Industries Ohio, Inc. USA, and Johnson M Fiberglass, Inc., rock, ceramic, carbon such as SGL Group The Carbon Company, Wiesbaden, Germany, Zoltech Corporation, St. Louis USA, Toho Tenax Europe GmbH, Wuppertal, Germany, or carbon fleece from companies such as carboNXT GmbH, Wischhafen, Germany, graphite, polyamide, aramid (NOMEX®, KEVLAR®), wool and cotton fibers of other organic and inorganic materials or mixtures thereof. Various metallic fibers such as copper and aluminum may also be utilized in various proportions with non-metallic fibers. The fibers amount to 20% to 60%, more preferably 35% to 60%, and most preferably 45% to 55% by volume of the composite.

Unidirectional fibers in the sense of the invention are those which e.g. allow for their being spread in sizes of e.g. 12k, 24k, 50k (k=1000) to 150 to 250 mm width, preferably to 170 to 220 mm width most preferably to 200 mm width and which are available under the trade names of PANEX® 35 from Zoltech, SIGRAFIL® C from SGL Group or Tenax® from Toho Tenax.

At least one layer of thermoplastic film and at least one layer of the surfaced treated fiber material are laminated into composite sheets and then optionally formed into an article. In one embodiment of the invention, the fiber material is woven cloth, unidirectional fibers or fiber tape or fiber fleece. In another embodiment of the invention, the fiber material is unidirectional fibers or fiber tape or fiber fleece. In an embodiment of the invention, several fiber materials may be combined, e.g. in different layers on top of one another. In another embodiment, the unidirectional fibers may be incorporated on the inside of a respective formed article while a woven cloth may appear in an outside layer. Particular attention should be laid to the process of creating a unidirectional layer and the slight spreading of the single fibers as described in published patent application DE102009056189 A1 “Vorrichtung und Verfahren zum Erzeugen einer UD-Lage”, DE102009056197 A1 “Verfahren and Vorrichtung zum Erzeugen einer UD-Lege” and DE102009043280 A1 “Halhzeug and Halbzeugverband” by Karl Mayer Malimo Textilmaschinenfabrik, Chemnitz, Germany, and the selection of the sizing.

The fiber can be advantageously surfaced treated with a polymer based sizing to enhance the staying of the single fiber in the polymer matrix. The polymer sizing works as an adhesion enhancer between fiber and matrix material. To this end, the nature of the polymer sizing has to be adapted to the respective fiber and/or matrix material. Fibers with an epoxyd comprising polymer sizing (silan sizing) find only limited application in thermoplastic matrix material. An adhesion enhancing polymer sizing can greatly contribute to better fiber/matrix adhesion and interaction. When thermoplastic polyurethane matrix raw materials are used, it is recommended to use polymer sizings made of polyurethane resins such as e.g. Toho Tenax 24k HTS-fiber F13. Other film forming polymer sizing may be starch derivatives, polymer and copolymers of vinyl acetate and acrylic esters, emulsions of epoxy resins, saturated and unsaturated polyesters, polypropylene, polybutylene terephthalate, polyamides, PVA, phenolic resins melamine resins and their respective mixtures, that additionally may comprise silanes as adhesion enhancer.

In an embodiment of the inventive lamination process, the roll-to-roll processing temperatures are between 180° to 230° C., preferably 185° to 210° C. more preferably 190° to 200° C. The velocity of the rolls may be from 8 to 12 m/min, prefrably from 9 to 11 m/min, more preferably at 10 m/min.

The nip has a value of 200 to 400 μm, preferably of 250 to 350 μm, more preferably 300 μm. The film can have a thickness of from 10 to 100 μm, preferably from 25 to 75 μm, more preferably 50 μm. The unidirectional fiber string may have a thickness of 200 to 400 μm, preferably from 250 to 350 μm, more preferably 300 μm and the resulting tape width has values between 150 to 300 μm, preferably between 200 to 250 mm, more preferably 220 mm. The machine has a width of 200 to 1000 mm, preferably, 500 to 750 mm, more preferably 600 mm.

In an embodiment of the invention, one film and one unidirectional fiber tape are laminated together, in a preferred embodiment two films are laminated together with a unidirectional fiber tape in the middle.

In another embodiment, the film material is a thermoplastic polyurethane, preferably art aromatic polyurethane. The at least one film, preferably two films, has a thickness of 50 μm while the unidirectional fiber string has a thickness of 300 μm which is spread to a width of 220 mm. The films are processed at a roll-to-roll temperature of 190 to 200° C. and the roll velocity is 10 m/min. The nip has a value of 300 μm.

The resulting reinforced film is then cut, preferably by water-jets and can then be further processed. In an embodiment of the invention, an organo sheet is formed by pressing at a temperature of 195 to 230° C., preferably 200 to 215° C., more preferably 210° C. and a pressure of 15 to 30 bar, preferably 18 to 25 bar, more preferably 20 bar. In one embodiment, a pressure of 20 bar at a temperature of 210° C. is applied to a thermoplastic polyurethane, preferably aromatic polyurethane, reinforced with unidirectional fibers.

It was surprisingly found that reinforced polyurethane films had excellent surface properties and considerably shorter processing times compared with reinforced polyamide films while showing similar or even better mechanical properties.

The composite materials made of at least one layer of thermoplastic film and at least one layer of the surfaced treated fiber material which may be woven cloth, unidirectional fibers or fiber fleece can be advantageously applied as structural reinforcement material in e.g. the automotive, bicycle, boat or air- or space craft sector such as roofs, bumpers, pillars, or as housing parts in the respective interior applications such as housings, seats, or as housings for portable or non-portable machines such as chain saws, borers or drillers, screw drivers etc.

The present invention will now be described for purposes of illustration and not limitation in conjunction with the figures and examples, wherein:

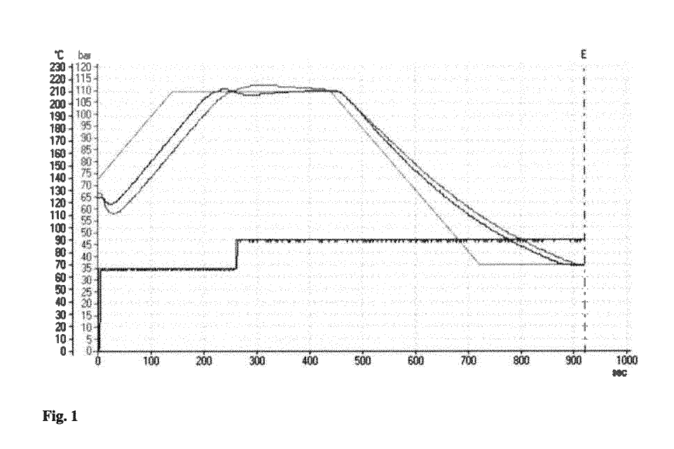

FIG. 1 shows a typical cyclic process flow of TPU and unidirectional fiber on a press.

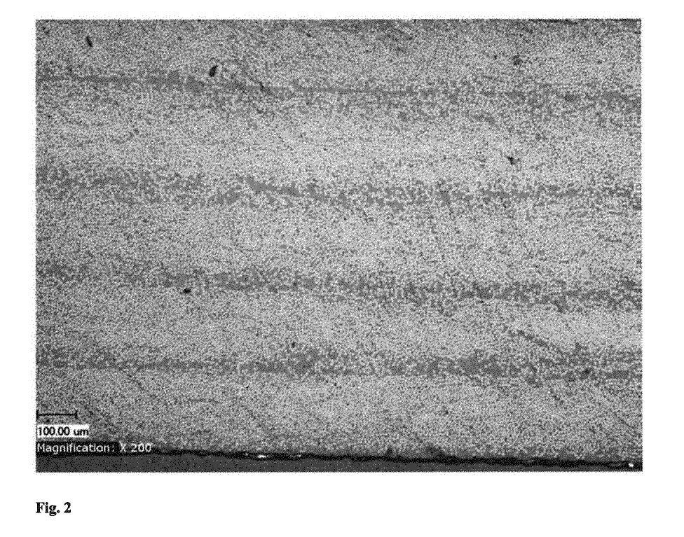

FIG. 2 shows a microscopic cross-sectional image of carbon fibers with a TPU-matrix—with approximately 41 vol.-% of fibers.

Thermoplastic composites processing with films.

At least one layer of thermoplastic film and one layer of fiber material which may be a woven cloth or unidirectional fibers or fleece are unwound from their individual rolls and guided to meet in a laminator comprising of heated nip rolls and nipping belts. Under pressure and heat applied by the nipping rolls and belts, the thermoplastic film layers turn into a melt and are squeezed to fill into all voids inside the fiber material as the laminating layers moving forward continuously inside the laminator. Upon exiting the laminator, the laminate is cooled to below melting or glass transition temperature of the thermoplastic film by passing through cooling rolls and consolidates into a rigid composite sheet or tape. The resultant composite sheet or tape is wound up into a roll for further forming and molding uses.

The present invention is further illustrated, but is not to be limited, by the following examples in which the following materials were used:

### EXAMPLE 1

TPU-film, a Dureflex® X2311 aromatic thermoplastic polyurethane film with a shore D value of 83, and UD-fibers were laminated in an own built thermo bonding machine by Cetex Institute wherein the fibers were arranged to a tape with uniform thickness and width between 150 mm and 250 mm. The lamination was used to fix the fibers, it was not intended to fully impregnate the fibers by the TPU film matrix. After laminating the tape was wound on a roll for further processing. For the production of impregnated composite sheets (organic sheets), a rectangular tool made of steel enclosed on all sides with a defined height was used to be fitted with the UD-tapes. The tool was closed with a steel plate. In a press manufactured by the company Dr. Collin Type P300 P/M the heating of the UD tapes, as well as the pressing of the single layers was performed. After cooling, the fully impregnated composite sheet was removed. A thermoforming to a geometric part can be done later. A typical cyclic process flow on a press is shown in FIG. 1.

TABLE 1
Parameters for the cyclic press flow as
shown in FIG. 1 for a sheet of 289 cm²

| Step | 1 | 2 | 3 | 4 |
|---|---|---|---|---|
| Time/sec | 1 | 260 | 180 | 480 |
| T top/° C. | 140 | 210 | 210 | 70 |
| T bottom/° C. | 140 | 210 | 210 | 70 |
| Temperature | 0 | 30 | 0 | 30 |
| Raise/K/min | | | | |
| Machine | 0 | 35 | 47 | 47 |
| Pressure/bar | | | | |
| Tool Pressure/ | 0 | 149 | 200 | 200 |
| N/cm² | | | | |
| Presssure Raise/ | 0 | 0 | 0 | 0 |
| bar/sec | | | | |

The sheets can then be water-jet cut and cut straps can be formed as well as samples for tensile stress, compression stress, impact resistance or bending tests. The samples are examined in a degree of 0°, 45° and 90° with respect to the UD fibers. Furthermore, the sheets can be thermoformined or high-pressure formed.

Following properties were determined for the UD fiber reinforced TPU prepared according to Example 1 and listed in Table 2:

TABLE 2
Properties of the fibers prepared according to example 1

| | Carbon | Carbon | Glass |
|---|---|---|---|
| | fibers - | fibers - | fibers - |
| | TPU (41 | TPU (50 | TPU (41 |
| | vol.-%) | vol.-%) | von.-%) |
| Tensile strength/MPa | 1.120 | 1.468 | 15 |
| Flexural modulus of | 89 | 122 | 25 |
| elasticity/GPa | | | |
| Bending strength/MPa | 320 | 1.226 | 17 |
| Bending elongation/% | 0.6 | 1.0 | 0.8 |
| Impact resistance/ | 98 | 80 | 125 |
| kJ/m² | | | |
| Shear strength/MPa | 27 | 66 | 16 |

A Zwick Z100 material testing machine with a macro displacement transducer was used to determine the flexural modulus, the bending strength and elongation according to DIN EN ISO 14125 and a Zwick Pendulum Z 25J was used to determine the impact resistance according to DIN EN ISO 179.

TPU films with a higher amount of Carbon fibers show significant higher mechanical strength than TPU films with lower amount of Carbon fiber volume. It is also notable that the strength of TPU-Carbon fiber sheet is clearly superior compared to Glass fiber sheet with the same TPU-matrix.

TABLE 3
Properties of reinforced TPU films compared
to reinforced polyamide (PA6) films

| | Carbon fibers - | Carbon fibers - |
|---|---|---|
| | TPU (50 vol.-%) | PA 6 (50 vol.-%) |
| Tensile strength/MPa | 1.468 | 1.094 |
| Flexural modulus of | 122 | 108 |
| elasticity/GPa | | |
| Flexural strength/MPa | 1.226 | 1.026 |
| Flexural strain/% | 1.0 | 0.9 |

Surprisingly reinforced TPU films (inventive films) show better mechanical properties than reinforced polyamide (PA 6) films if they are comparable strengthened (Table 3). The inventive films are easier and faster to be processed and handled.

Instead of a composite plate, the individual UD tapes can be formed also in a geometric three-dimensional structure to a structural component.

After the first trials with the TPU film in thermoplastic composites area, the following effects were observed:
very good impregnation behavior of glass fibers and carbon fibers to the TPU matrix
almost every single filament with TPU matrix enclosed (see also the microscopic cross-sectional images of the composite laminates, FIG. 2)
good processing behavior
very suitable for the production of composites.

Surprisingly, it turned out that very good optical surfaces can be produced with the TPU film and the surface of the tool is very well mapped. Matrix resin buildup on the tool is very easy to remove without expensive mechanical cleaning. The use of mold release agents is not required.

The thermoplastic/fiber composite sheets made by the instant process may preferably be used to make parts by thermoforming in short molding cycles and they are recyclable. These parts possess good chemical resistance, mechanical properties and are paintable or printable without priming or other surface preparations.

Various aspects of the subject matter described herein are set out in the following numbered clauses in any combination thereof:

1. A roll-to-roll continuous manufacturing process for producing a thermoplastic composite laminate comprising: extruding a thermoplastic resin into a film article; surface treating a fiber material with a polymer sizing; and laminating at least one layer of thermoplastic film and at least one layer of the surfaced treated fiber material into a composite sheet at a temperature above the melting or softening point of the thermoplastic film and under pressure applied by nipping rolls or nipping belts, whereby the fiber material are unidirectional fibers, woven cloth, fiber fleece or combinations thereof.

2. The process according to claim 1 fiirther including adding a silane coupling agent to the thermoplastic film.

3. The process according to Claims 1 or 2 further including adding a silane coupling agent to the polymer sizing.

4. The process according to any of Claims 1 to 3, wherein the extruding is by one selected from the group consisting of a blown film process and a flat-die process.

5. The process according to any of claims 1 to 4, wherein the thermoplastic resin is selected from the group consisting of thermoplastic polyurethane, polyethylene terephthalate glycol-modified copolyester, polycarbonate, poly(methyl methacrylate), polycarbonatelacrylonitrile butadiene styrene blend and polystyrene.

6. The process according to claim 5, wherein the thermoplastic resin is polyurethane.

7. The process according to claim 6, wherein the polyurethane has soft segments in its backbone structure and hardness between 50-80 Shore D.

8. The process according to claim 6, wherein the polyurethane has no soft segments in its backbone structure and has a hardness above 80 Shore D.

9. The process according to any of Claims 1 to 8, wherein the polymer sizing is selected from the group consisting of polyurethane, epoxy, phenolic and polyacrylate based dispersion in water or an organic solvent.

10. The process according to any of Claims 1 to 9, wherein the polymer sizing is a dispersion of polyurethane in water.

11. The process according to any of Claims 1 to 10, wherein the fibers are selected ftom the group consisting of glass, rock, ceramic, carbon, graphite, polyamide, aramid, wool cotton, copper and aluminum and combinations thereof.

12. A thermoplastic composite laminate made according to the process of any of Claims 1 to 11.

13. An article made of the thermoplastic laminate according to claim 12.

14. Use of an article according to claim 14 as structural reinforcement part in automotive, bicycle, boat or air-or space craft sector as housing parts for machines, whereby the fibers material are unidirectional fibers, woven cloths, fiber fleece or combinations thereof.

The foregoing examples of the present invention are offered for the purpose of illustration and not limitation. It will be apparent to those skilled in the art that the embodiments described herein may be modified or revised in various ways without departing from the spirit and scope of the invention, The scope of the invention is to be measured by the appended claims.

1.-14. (canceled)

15. A roll-to-roll continuous manufacturing process for producing a thermoplastic composite laminate comprising:
extruding a thermoplastic resin into a film article;
surface treating a fiber material with a polymer sizing; and
laminating at least one layer of thermoplastic film and at least one layer of the surfaced treated fiber material into a composite sheet at a temperature above the melting or softening point of the thermoplastic film and under pressure applied by nipping rolls or nipping belts, whereby the fiber material are unidirectional fibers, woven cloth, fiber fleece or combinations thereof

16. The process according to claim 15 further including adding a silane coupling agent to the thermoplastic film.

17. The process according to claim 15 further including adding a silane coupling agent to the polymer sizing.

18. The process according to claim 15, wherein the extruding is by one selected from the group consisting of a blown film process and a flat-die process.

19. The process according to claim 15, wherein the thermoplastic resin is selected from the group consisting of thermoplastic polyurethane, polyethylene terephthalate glycol-modified copolyester, polycarbonate, polycarbonate copolymer, poly(methyl methacrylate), polycarbonate/acrylonitrile butadiene styrene blend and polystyrene.

20. The process according to claim 19, wherein the thermoplastic resin is polyurethane.

21. The process according to claim 20, wherein the polyurethane has soft segments in its backbone structure and a hardness between 50-80 Shore D.

22. The process according to claim 20, wherein the polyurethane has no soft segments in its backbone structure and has a hardness above 80 Shore D.

23. The process according to claim 15, wherein the polymer sizing is selected from the group consisting of polyurethane, epoxy, phenolic and polyacrylate based dispersion in water or an organic solvent.

24. The process according to claim 15, wherein the polymer sizing is a dispersion of polyurethane in water.

25. The process according to claim 15, wherein the fibers are selected from the group consisting of glass, rock, ceramic, carbon, graphite, polyamide, aramid, wool cotton, copper and aluminum and combinations thereof.

26. A thermoplastic composite laminate made according to the process of claim 15.

27. An article made of the thermoplastic laminate according to claim 26.

28. A method comprising utilizing the article according to claim 27 as structural reinforcement part in automotive, bicycle, boat or air- or space craft sector as housing parts for machines, whereby the fibers material are unidirectional fibers, woven cloth, fiber fleece or combinations thereof.
